(19) United States
(12) Patent Application Publication
(10) Pub. No.: US 2026/0322085 A1
(43) Pub. Date: Oct. 15, 2026

(54) CABLE ORGANIZER AND CABLE ASSEMBLY

(71) Applicant: BIZLINK INTERNATIONAL CORP., New Taipei City (TW)

(72) Inventors: Pengfei MAO, New Taipei City (TW); Xiangwu WANG, New Taipei City (TW); Chubei ZHANG, New Taipei City (TW)

(21) Appl. No.: 19/646,611

(22) Filed: Apr. 14, 2026

(30) Foreign Application Priority Data
Apr. 15, 2025 (CN) 202520705310.7

(51) Int. Cl. H02G 3/04

(52) U.S. Cl. CPC H02G 3/0456

(57) ABSTRACT

A cable organizer for an overmolded cable assembly includes a horizontal plate, a plurality of partition walls, and a protruding portion. The horizontal plate has an upper side and a lower side. The partition walls are arranged on the upper side and the lower side of the horizontal plate and are spaced apart from each other. The protruding portion extends from the horizontal plate and includes a plurality of guiding slots. The accommodating slots are formed between adjacent two of the partition walls. The accommodating slots respectively communicate with the guiding slots. A cross-section shape of the accommodating slots is different from a cross-section shape of the guiding slots.

### CROSS - REFERENCE TO RELATED APPLICATION

This application claims priority to China Application Serial Number 202520705310.7, filed April 15, 2025, which is herein incorporated by reference in its entirety.

### BACKGROUND

### Field of Invention

The present disclosure relates to a cable organizer and a cable assembly. More particularly, the present disclosure relates to a cable organizer that can uniformly manage cables and a cable assembly that is easy to assemble.

### Description of Related Art

As the cornerstone of industrial power transmission, the importance of cable assemblies is self-evident. Through proper selection and scientific design, the efficient, safe, and reliable operation of the power system can be ensured.

However, with the increase in power supply demand, the size and number of cables have also become larger and more complex, making it difficult and inconvenient to manage the cables.

Accordingly, providing a cable organizer and a cable assembly that can solve the aforementioned problems has become an important issue for those skilled in the industry.

### SUMMARY

An aspect of the disclosure is to provide a cable organizer and a cable assembly that can efficiently solve the aforementioned problems.

According to an embodiment of the disclosure, a cable organizer for an overmolded cable assembly includes a horizontal plate, a plurality of partition walls, and a protruding portion. The horizontal plate has an upper side and a lower side. The partition walls are arranged on the upper side and the lower side of the horizontal plate and are spaced apart from each other. The protruding portion extends from the horizontal plate and includes a plurality of guiding slots. The accommodating slots are formed between adjacent two of the partition walls. The accommodating slots respectively communicate with the guiding slots. A cross-section shape of the accommodating slots is different from a cross-section shape of the guiding slots.

According to an embodiment of the disclosure, a cable assembly includes a plurality of cables, a cable organizer, and an outer mold. The cable organizer includes a plurality of accommodating slots spaced apart from each other. Each of the accommodating slots is configured to accommodate a portion of each of the cables and allow the portion of each of the cables to extend through. The outer mold partially covers the cable organizer and the cables to fix at least the portions of the cables within the accommodating slots. The cable organizer includes a protruding portion extending out of the outer mold.

Accordingly, the cable organizer and the cable assembly facilitate cable management and assembly. By having the protruding portion extend beyond the end face of the outer mold, the cables are separated and maintained in position.

It is to be understood that both the foregoing general description and the following detailed description are exemplary and are intended to provide further explanation of the disclosure as claimed.

### BRIEF DESCRIPTION OF THE DRAWINGS

The disclosure can be more fully understood by reading the following detailed description of the embodiments with reference to the accompanying drawings, as follows:

FIG. 1 is a perspective view of a cable assembly according to an embodiment of the present disclosure;

FIG. 2 is a front view of the cable assembly in FIG. 1;

FIG. 3 is a perspective view of the cable assembly in FIG. 1 after removing an outer mold;

FIG. 4 is an exploded view of the cable assembly in FIG. 3;

FIG. 5 is a front view of a cable organizer in FIG. 4;

FIG. 6 is a cross-section view of accommodating slots taken alone line A-A in FIG. 3; and

FIG. 7 is a cross-section view of guiding slots taken alone line B-B in FIG. 3.

### DETAILED DESCRIPTION

Reference will now be made in detail to the present embodiments of the disclosure, examples of which are illustrated in the accompanying drawings. Wherever possible, the same reference numerals are used in the drawings and the description to refer to the same or like parts. However, specific structural and functional details disclosed herein are merely representative for purposes of describing example embodiments, and thus may be embodied in many alternative forms and should not be construed as being limited to only the example embodiments set forth herein. Therefore, it should be understood that there is no intent to limit the example embodiments to the particular forms disclosed; on the contrary, the example embodiments are intended to cover all modifications, equivalents, and alternatives falling within the scope of the disclosure.

To help readers better understand the interrelationships and orientations of the various components, the drawings indicate coordinate axes including an X-axis, a Y-axis, and a Z-axis. Furthermore, the X-axis, the Y-axis, and the Z-axis are perpendicular to each other.

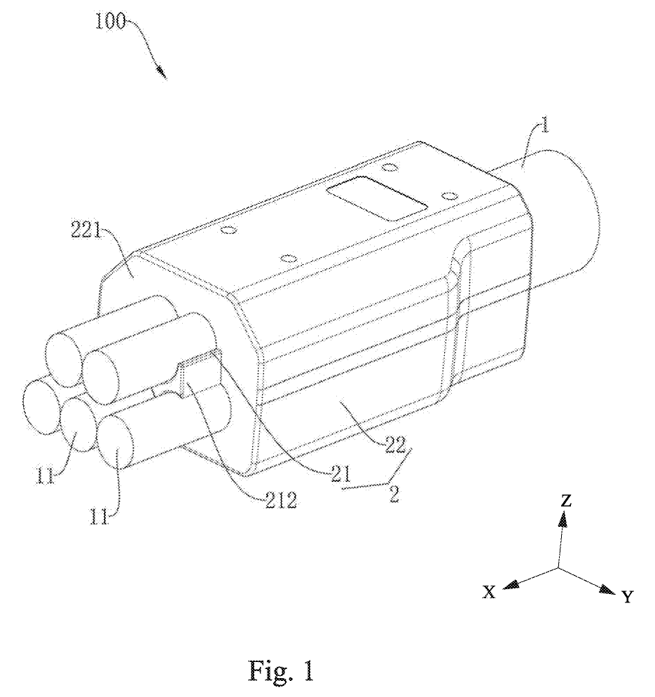

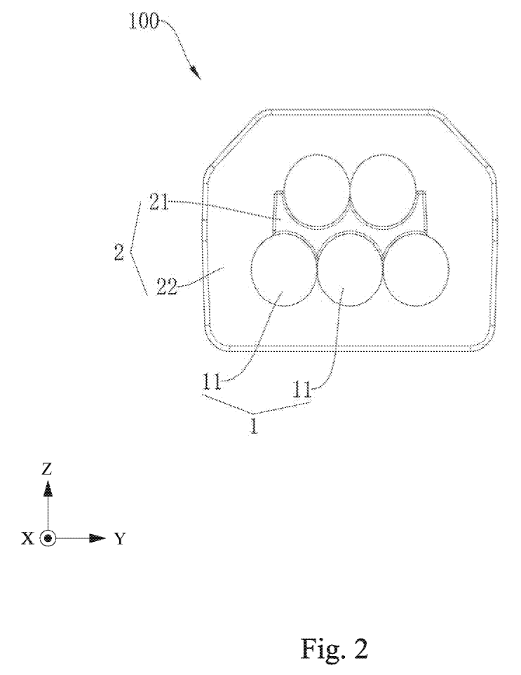

Reference is made to FIGS. 1 and 2. FIG. 1 is a perspective view of a cable assembly 100 according to an embodiment of the present disclosure. FIG. 2 is a front view of the cable assembly 100 in FIG. 1. As shown in FIGS. 1 and 2, in the present embodiment, the cable assembly 100 includes a main cable 1 and a cable management module 2. The cable management module 2 may be disposed at a head end, a tail end, or a body portion of the main cable 1. In the present embodiment, the main cable 1 includes sub-cables 11. A high-current connector (not shown) may be connected to either end of the main cable 1. The cable management module 2 includes a cable organizer 21 and an outer mold 22 for the overmolded cable assembly 100. The cable management module 2 may position and independently separate the sub-cables 11 through the cable organizer 21, and cover and fix the sub-cables 11 through the outer mold 22. The outer mold 22 may, for example, cover the sub-cables 11 by an injection molding process.

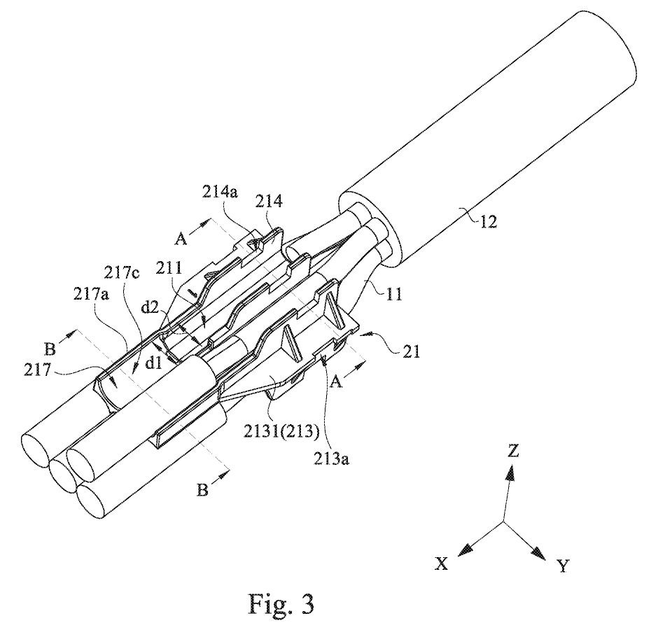

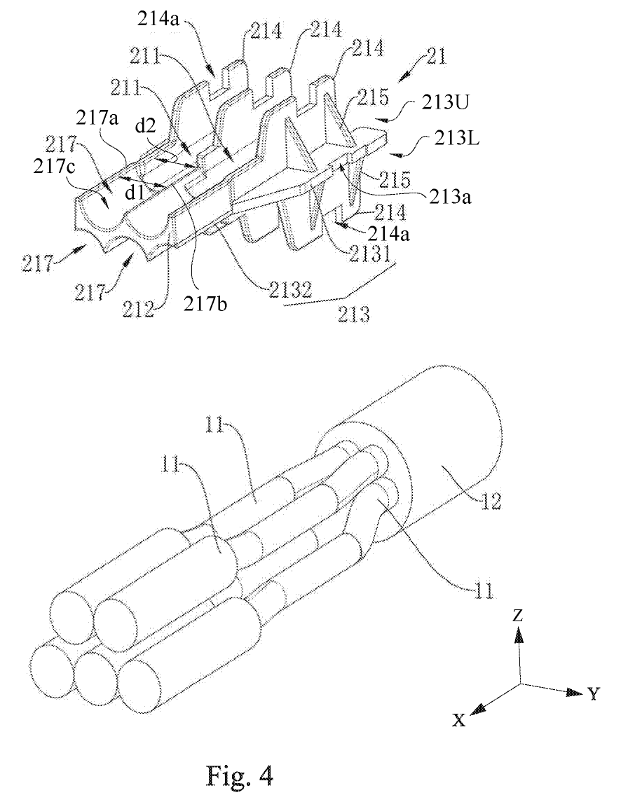

Reference is made to FIGS. 3 and 4. FIG. 3 is a perspective view of the cable assembly 100 in FIG. 1 after removing the outer mold 22. FIG. 4 is an exploded view of the cable assembly 100 in FIG. 3. As shown in FIGS. 3 and 4, and with reference to FIG. 1, in the present embodiment, the cable organizer 21 includes accommodating slots 211 which are spaced apart from each other. Each of the accommodating slots 211 is configured to accommodate a corresponding one of the sub-cables 11 and allow the portion of the sub-cables 11 to extend through. In the present embodiment, the outer mold 22 partially covers the cable organizer 21 and the sub-cables 11 to fix at least the portions of the sub-cables 11 within the accommodating slots 211. In other words, the accommodating slots 211 may ensure that the sub-cables 11 are separated from each other before being covered by the outer mold 22, so that the sub-cables 11 may be separated in sequence according to the usage requirements and then extend from the cable organizer 21 and the outer mold 22, so as to quickly connect and fix the sub-cables 11 one by one to terminals of the high-current connector (not shown).

As shown in FIG. 1, and with reference to FIGS. 2 and 3, in the present embodiment, the cable organizer 21 has a protruding portion 212 extending out of the outer mold 22 from an end face 221 of the outer mold 22 and located between the sub-cables 11. In other words, the cable organizer 21 is not completely enclosed within the outer mold 22, but rather partially exposed and forms the protruding portion 212. In the present embodiment, a portion of the sub-cables 11 which is not covered by the outer mold 22 extends beyond the end face 221 of the outer mold 22 and is separated by the protruding portion 212, thereby preventing the outer mold 22 from pressing on the sub-cables 11 due to a mold flash during the injection molding process, which could cause displacement of the sub-cables 11. In other words, the protruding portion 212 may prevent the outer mold 22 from flowing into gaps between the uncovered portion of each sub-cables 11 during the injection molding process, ensuring that each of the sub-cables 11 is evenly spaced and does not deform in position, so as to be accurately connected to the high-current connector (not shown).

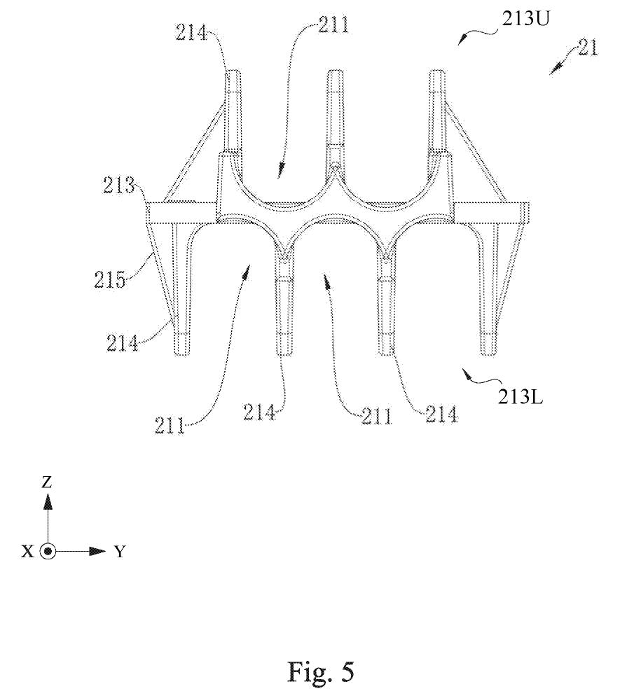

Reference is made to FIG. 5. FIG. 5 is a front view of the cable organizer 21 in FIG. 4. As shown in FIGS. 3 to 5, in the present embodiment, the cable organizer 21 includes a horizontal plate 213 and vertical plates 214 (also referred to as partition walls). The vertical plates 214 are arranged side by side and spaced apart from each other on at least one side of the horizontal plate 213, and one of the accommodating slots 211 is formed between adjacent two of the vertical plates 214 to receive the sub-cables 11 therein. In the present embodiment, a side of each of the accommodating slots 211 away from the horizontal plate 213 is designed to be open, so as to facilitate the placement and fixing of each of the sub-cables 11.

As shown in FIGS. 3 to 5, in the present embodiment, the vertical plates 214 are arranged on an upper side 213U and a lower side 213L of the horizontal plate 213. The accommodating slots 211 on the upper side 213U and the accommodating slots 211 on the lower side 213L are arranged in a staggered manner. In the present embodiment, three of the vertical plates 214 are disposed on the upper side 213U of the horizontal plate 213, and two of the accommodating slots 211 are formed between three of the vertical plates 214. Four of the vertical plates 214 are disposed on the lower side 213L of the horizontal plate 213 and three of the accommodating slots 211 are formed between four of the vertical plates 214. Two of the accommodating slots 211 on the upper side 213U are respectively located above adjacent two of the accommodating slots 211 of three of the accommodating slots 211 on the lower side 213L, thus achieving the staggered manner of the accommodating slots 211 to meet the connection arrangement requirements of the sub-cables 11 and the high-current connector (not shown). It should be noted that the specific number and distribution of the accommodating slots 211 and the number of the sub-cables 11 may be reasonably adjusted and changed according to the model of the high-current connector, which is a routine adjustment that can be made by those skilled in the art.

As shown in FIGS. 3 to 5, in the present embodiment, the cable organizer 21 further includes a reinforcing rib 215. The reinforcing rib 215 is connected to the horizontal plate 213 and an outermost one of the vertical plates 214. In the present embodiment, the reinforcing rib 215 is triangular, but the disclosure is not limited in this regard. In some embodiments, the reinforcing rib 215 may be any other shape that can be adapted between the horizontal plate 213 and the outermost one of the vertical plates 214. The reinforcing rib 215 is provided to improve the strength of the vertical plate 214 of the cable organizer 21, and increase the overall structural strength of the cable organizer 21 to meet the needs of the sub-cables 11 with high current and large diameter.

As shown in FIGS. 3 and 4, in the present embodiment, the horizontal plate 213 has a first notch 213a. The first notch 213a may be disposed on an edge of horizontal plate 213. Each of the vertical plates 214 has a second notch 214a on a side away from the horizontal plate 213. The first notch 213a and the second notch 214a may increase the contact area between the outer mold 22 and the cable organizer 21 during the injection molding process, thereby improving the bonding strength between the outer mold 22 and the cable organizer 21. In the present embodiment, the first notch 213a and the second notch 214a are aligned with each other along a direction (i.e., the Y-axis) perpendicular to the horizontal plate 213. Specifically, the first notch 213a and the second notch 214a are at least partially located on a cross section taken alone line A-A, and the cross section A-A is substantially perpendicular to the horizontal plate 213 and the vertical plates 214. In other words, the cross section A-A passes through both the first notch 213a and the second notch 214a. Based on this configuration, when the sub-cables 11 are accommodated in the accommodating slots 211, a strap (not shown) may be simultaneously tied to the first notch 213a and the second notch 214a (i.e., the periphery of the cable organizer 21) before covering the outer mold 22, so as to initially fix the sub-cables 11 in the cable organizer 21 and prevent the sub-cables 11 from shifting.

As shown in FIGS. 3 and 4, in the present embodiment, the horizontal plate 213 includes an inner plate 2131 and an outer plate 2132. The vertical plates 214 are disposed on the inner plate 2131. The protruding portion 212 is disposed on the outer plate 2132 (i.e., a portion of the outer plate 2132 that extends beyond the end face 221 of the outer mold 22 forms the protruding portion 212). In the present embodiment, the cable organizer 21 further includes guiding slots 217. The guiding slots 217 are formed on the outer plate 2132 and are respectively aligned with and communicate with the accommodating slots 211. In the present embodiment, each of the guiding slots 217 has a concave arc surface 217c to facilitate the placement of each of the sub-cables 11, but the disclosure is not limited in this regard.

As shown in FIGS. 3 and 4, in the present embodiment, each of the guiding slots 217 has a first edge 217a and a second edge 217b opposite to each other. The first edge 217a is connected to one of the vertical plates 214 and the second edge 217b is connected to another of the vertical plates 214, thereby communicating each of the accommodating slots 211 with each of the guiding slots 217. In the present embodiment, a maximum distance d1 from the first edge 217a to the second edge 217b is greater than a distance d2 from the one of the vertical plates 214 to the another of the vertical plates 214. In other words, a maximum width of each of the guiding slots 217 in the Y-axis is greater than a width of each of the accommodating slots 211 in the Y-axis. Based on this configuration, the sub-cable 11 located in the guiding slot 217 may be prevented from displacing toward a corresponding one of the accommodating slots 211. In the present embodiment, the cable assembly 100 further includes an outer covering layer 12. The outer covering layer 12 covers a periphery of each of the sub-cables 11 of the main cable 1 by means of, for example, injection molding or other methods.

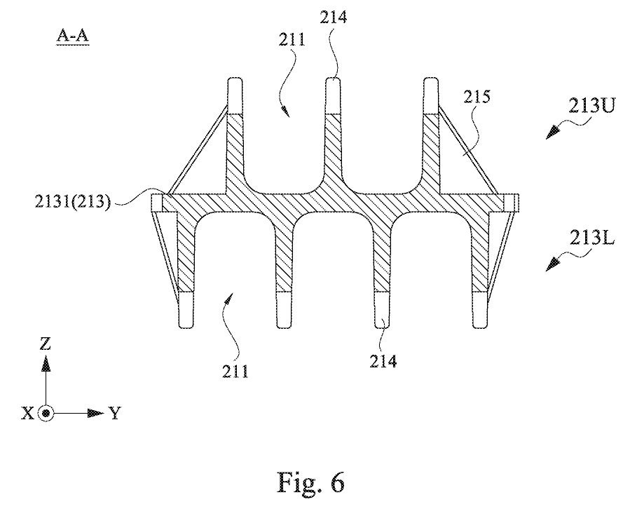

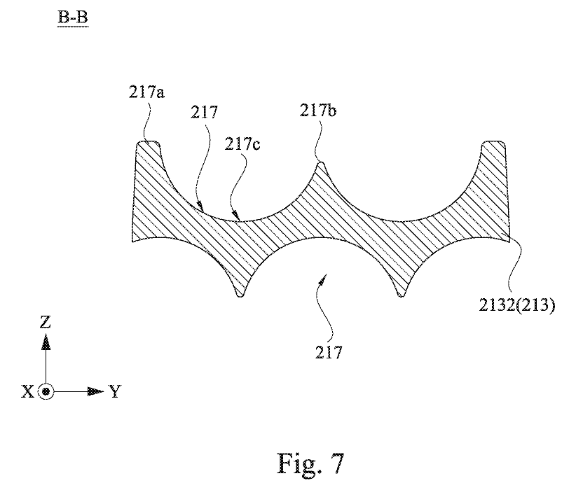

Reference is made to FIGS. 6 and 7. FIG. 6 is a cross-section view of the accommodating slots 211 taken alone line A-A in FIG. 3. FIG. 7 is a cross-section view of the guiding slots 217 taken alone line B-B in FIG. 3. As shown in FIGS. 6 and 7, in the present embodiment, a cross-section shape of the accommodating slots 211 is different from a cross-section shape of the guiding slots 217. Specifically, the cross-section shape of each of the guiding slot 217 has a more uniform curvature than the cross-section shape of each of the accommodating slot 211 to more completely fit the outer shape of the sub-cable 11, thereby effectively filling the gap between the sub-cables 11 and preventing the sub-cables 11 from displacing due to the mold flash.

According to the foregoing embodiments of the disclosure, in the cable organizer and the cable assembly of the present disclosure, the cable organizer may eliminate the complicated cable management process, improve the production and assembly efficiency of the high-current connector, and enhance product stability. By extending the cable organizer beyond the end face of the outer mold, it is possible to prevent the cables from being compressed due to the mold flash and to prevent the cables from displacing.

Although the present disclosure has been described in considerable detail with reference to certain embodiments, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations provided they fall within the scope of the following claims.

What is claimed is:

1. A cable organizer for an overmolded cable assembly, comprising:
a horizontal plate having an upper side and a lower side;
a plurality of partition walls arranged on the upper side and the lower side of the horizontal plate and spaced apart from each other; and
a protruding portion extending from the horizontal plate and comprising a plurality of guiding slots;
wherein a plurality of accommodating slots are formed between adjacent two of the partition walls, the accommodating slots respectively communicate with the guiding slots, and a cross-section shape of the accommodating slots is different from a cross-section shape of the guiding slots.

2. The cable organizer of claim 1, wherein the accommodating slots on the upper side and the accommodating slots on the lower side are arranged in a staggered manner.

3. The cable organizer of claim 1, further comprising a reinforcing rib connected between the horizontal plate and an outermost one of the partition walls.

4. The cable organizer of claim 3, wherein the reinforcing rib is triangular.

5. The cable organizer of claim 1, wherein the horizontal plate has a first notch, and each of the partition walls has a second notch on a side away from the horizontal plate.

6. The cable organizer of claim 5, wherein the first notch and the second notch are aligned with each other along a direction perpendicular to the horizontal plate.

7. The cable organizer of claim 1, wherein the horizontal plate comprises an inner plate and an outer plate, the partition walls are disposed on the inner plate, the protruding portion is disposed on the outer plate, and the guiding slots are formed on the outer plate and respectively aligned with the accommodating slots.

8. The cable organizer of claim 7, wherein each of the guiding slots has a concave arc surface.

9. The cable organizer of claim 7, wherein each of the guiding slots has a first edge and a second edge opposite to each other, the first edge is connected to one of the partition walls, the second edge is connected to another of the partition walls, and a maximum distance from the first edge to the second edge is greater than a distance between the partition walls.

10. A cable assembly, comprising:
a plurality of cables;
a cable organizer comprising a plurality of accommodating slots spaced apart from each other, each of the accommodating slots being configured to accommodate a portion of each of the cables and allow the portion of each of the cables to extend through; and
an outer mold partially covering the cable organizer and the cables to fix at least the portions of the cables within the accommodating slots;
wherein the cable organizer comprises a protruding portion extending out of the outer mold.

11. The cable assembly of claim 10, wherein the cable organizer comprises a horizontal plate and a plurality of partition walls are spaced apart from each other, and the accommodating slots are formed between adjacent the partition walls and receive the cables therein.

12. The cable assembly of claim 11, wherein the partition walls are disposed on an upper side and a lower side of the horizontal plate, and the accommodating slots on the upper side and the accommodating slots on the lower side are arranged in a staggered manner.

13. The cable assembly of claim 11, further comprising a reinforcing rib connecting the horizontal plate to an outermost one of the partition walls.

14. The cable assembly of claim 13, wherein the reinforcing rib is triangular.

15. The cable assembly of claim 11, wherein the horizontal plate has a first notch, and each of the partition walls has a second notch on a side away from the horizontal plate.

16. The cable assembly of claim 15, wherein the first notch and the second notch are at least partially located on a cross section substantially perpendicular to the horizontal plate and the partition walls.

17. The cable assembly of claim 11, wherein the horizontal plate comprises an inner plate and an outer plate, the partition walls are disposed on the inner plate, and the protruding portion is located on the outer plate.

18. The cable assembly of claim 17, wherein the protruding portion comprises a plurality of guiding slots being respectively communicate with the accommodating slots, and each of the guiding slots has a concave arc surface.

19. The cable assembly of claim 18, wherein each of the guiding slots has a first edge and a second edge opposite to each other, the first edge is connected to one of the partition walls, the second edge is connected to another of the partition walls, and a maximum distance from the first edge to the second edge is greater than a distance from the one of the partition walls to the another of the partition walls.

20. The cable assembly of claim 10, further comprising an outer covering layer covering a periphery of each of the cables.
